(19) United States
(12) Patent Application Publication
(10) Pub. No.: US 2008/0084346 A1
(43) Pub. Date: Apr. 10, 2008

(54) Radar system having a plurality of range measurement zones

(76) Inventors: Jurgen Minichshofer, Linz (AT); Franz Reininger, Villach (AT)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/641,529

(22) Filed: Dec. 19, 2006

(30) Foreign Application Priority Data
Oct. 5, 2006 (DE) 10 2006 047 183.0

(51) Int. Cl. G01S 13/08

(52) U.S. Cl. 342/118; 342/385

(57) ABSTRACT

One embodiment includes a radar system for range measurement having a first operating mode for measurement in a first range zone and having a second operating mode for measurement in a second range zone. The radar system includes a radio-frequency transmission module, at least one antenna, and a control and processing unit. The radio-frequency transmission module has an oscillator for providing a transmission signal with a first frequency spectrum in the first operating mode, and with a second frequency spectrum in the second operating mode. The at least one antenna is connected to the radio-frequency module. The control and processing unit provides control signals which are supplied to the radio-frequency transmission module for selecting the operating modes.

### CROSS-REFERENCE TO RELATED APPLICATIONS

This Utility Patent Application claims priority to German Patent Application No. DE 10 2006 047 183.0 filed on Oct. 5, 2006, which is incorporated herein by reference.

### BACKGROUND

One embodiment relates to a radar system having different range measurement zones, and for use in an automobile. Known radar systems which are currently used for distance measurement in vehicles essentially include two separate radars which operate in different frequency bands. For distance measurements in a near area (short range radar), radars which operate in a frequency band around a mid-frequency of 24 GHz are commonly used. In this case, the expression near area means distances in the range from 0 to about 20 meters from the vehicle (short range radar). The frequency band from 76 GHz to 77 GHz is currently used for distance measurements in the far area, that is to say for measurements in the range from about 20 meters to around 200 meters (long range radar).

Fundamentally, the frequency band from 77 GHz to 81 GHz is likewise suitable for short range radar applications. A single multirange radar system which carries out distance measurements in the near area and far area using a single radio-frequency transmission module (RF front end) has, however, not yet been feasible for various reasons. One reason is that circuits which are manufactured using III/V semiconductor technologies (for example gallium-arsenide technologies) are used at the moment to construct known radar systems. Gallium-arsenide technologies are admittedly highly suitable for the integration of radio-frequency components, but it is not possible to achieve a degree of integration which is as high, for example, of that which would be possible with silicon integration, as a result of technological restrictions. Furthermore, only a portion of the required electronics are manufactured using GaAs technology, so that a large number of different components are required to construct the overall system.

Furthermore, suitable radio-frequency oscillators for the transmission stage, which can be tuned throughout the entire frequency range from 76 GHz to 81 GHz have become possible only as a result of the latest production processes. However, there is still the need for an integrated multirange radar suitable for covering a plurality of range measurement zones and which in the process requires only a single radio-frequency transmission module.

### SUMMARY

The radar system according to one embodiment of the invention has a first operating mode for measurement in a first range zone (near area) and a second operating mode for measurement in a second range zone (far area). The radar system has a radio-frequency (RF) transmission module with an oscillator for providing a transmission signal with a first frequency spectrum in the first operating mode, and with a second frequency spectrum in the second operating mode. It also has at least one antenna, which is connected to the RF transmission module, and a control and processing unit, which provides control signals which are supplied to the RF transmission module for setting the operating modes. The oscillator that is used can be tuned by means of a control voltage over a frequency range which includes the frequencies of both frequency spectra. An oscillator such as this can be produced only by the use of the very latest bipolar and BiCMOS technologies.

In one embodiment of the invention, the transmission/reception characteristics of the transmitting and receiving antennas that are used can be switched by means of a control signal which is produced by the control and processing unit. In a further embodiment of the invention, at least two different antennas with different transmission and reception characteristics are provided for the two operating modes, wherein only one of the two antennas is active, as a function of the operating mode. Control signals are likewise used for switching between the antennas, and are provided by the control and processing unit. A multirange radar according to this embodiment operates using the time-division multiplexing mode.

In a further embodiment of the invention, the two antennas are not activated with a time offset, but they transmit and receive signals in different frequency ranges at the same time. In this case, one frequency range is in each case associated with one antenna (or a group of antennas) and one measurement range (short range or long range). A multirange radar according to this embodiment operates using the frequency-division multiplexing mode.

The use of the already mentioned modern bipolar or BiCMOS production methods for the first time allows a multirange radar system to be integrated using a single semiconductor technology. The use of a transmission oscillator which can be tuned over a very wide range and of a suitable control unit which allows switching between antennas for the short range and for the long range or, when using a common antenna for both measurement ranges, switching of the reception characteristics of one antenna, allows the “combination” of a short-range radar and a long-range radar in a single multirange radar system with a considerable reduction of components. The cost reduction associated with this is a major precondition for the use of radars in lower and medium price-class vehicles.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates an embodiment of the invention in which the same antenna is used in both operating modes.

FIG. 2 illustrates a further embodiment of the invention, with different antennas for the two operating modes.

FIG. 3 is a more detailed illustration of the embodiment illustrated in FIG. 2.

FIG. 4 is a more detailed illustration of the embodiment illustrated in FIG. 3.

FIG. 5 is an alternative to the embodiment illustrated in FIG. 4.

FIG. 6 illustrates the internal design of the transmission oscillator in the form of a block diagram.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

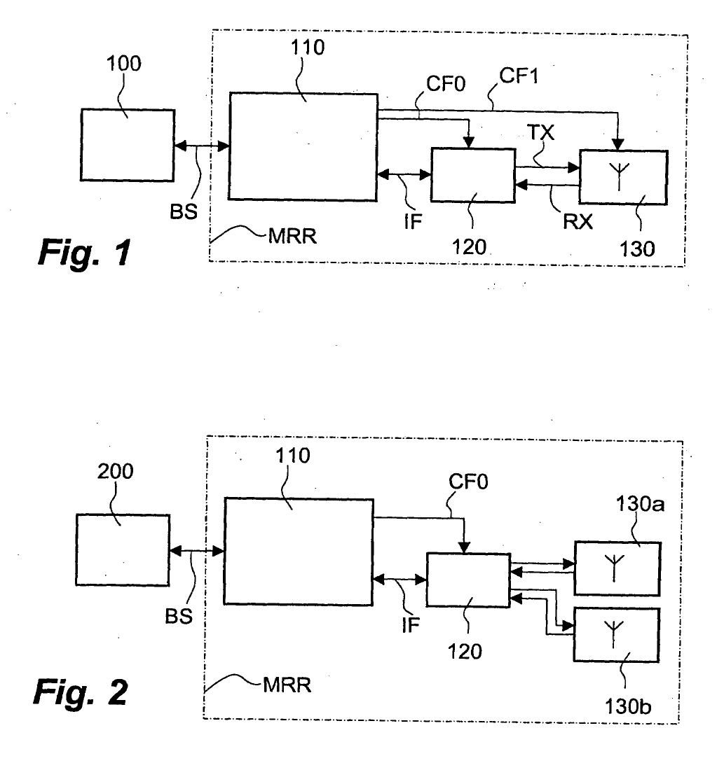

FIG. 1 uses a block diagram to illustrate the basic structure of one embodiment of the inventive radar system. The actual multirange radar MRR has a control and processing unit 110 which is connected to the other vehicle components 100 via a specific interface, for example the vehicle bus. The multirange radar MRR also has a radio-frequency (RF) transmission module 120 and an antenna module 130 which has one or more individual antennas. The control and processing unit 110 is designed predominantly using CMOS technology, and the RF transmission module 120 is designed predominantly using bipolar technology. However, it is also possible to integrate both parts jointly using BiCMOS technology. The multirange radar has at least two range measurement zones, a near area for ranges between 0 and about 20 meters (short range radar), and a far area with ranges from around 20 meters to about 200 meters (long range radar). Since both the transmission and reception characteristics of the active antennas as well as the required bandwidth of the transmitted radar signal are different in these two measurement ranges, both the antenna module 130 and the radio-frequency transmission module 120 can be configured by means of control signals CF0 and CF1, which are provided by the control and processing unit 110, in accordance with the desired measurement range. The details of this configuration capability will be explained in more detail further below.

An antenna with a fairly broad emission angle is desirable for a measurement in the short range and an antenna with a narrow emission angle and a high antenna gain is desirable for measurement in the long range. For this reason, phased-array antennas can be used, by way of example, in the antenna module 130, whose transmission/reception angle can be varied by driving different antenna elements with the same antenna signal, but with a different transmission signal phase angle. Variation of the transmission and reception characteristics of antennas by means of an appropriate driver is also referred to as electronic beam control or digital beamforming.

The RF transmission module 120 also includes the radio-frequency section which is required for the reception of the reflected radar signals. The received radar signals are mixed with the aid of a mixer to baseband, the baseband signal IF is then supplied from the radio-frequency transmission module 120 to the control and processing unit 110, which digitizes the baseband signal IF and processes it further by digital signal processing. It is not only possible to provide a separate transmitting antenna and receiving antenna, but also a common antenna for transmission and reception of radar signals. In the second case, a directional coupler is required to separate the transmitted signals and the received signals. The internal design of the RF transmission module 120 and of the antenna modules 130 will likewise be described in more detail later.

Electronic beam control (digital beamforming) admittedly allows a minimal number of components, but requires considerably greater control logic complexity. For this reason, different antennas 130a and 130b can also be used for the different measurement ranges, as is illustrated in the exemplary embodiment illustrated in FIG. 2. The block diagram in FIG. 2 differs from that in FIG. 1 only in that two antenna modules 130a and 130b are provided instead of the antenna module 130 which can be configured via the control signal CF1, and their emission and reception characteristics are not adjustable. For example, the antenna 130a is designed only for measurements in the short range, and the antenna 130b is designed only for measurements in the long range. However, the transmission signals are generated and the received signals are mixed in a common radio-frequency transmission module 120. In principle, when using two antennas, it is also possible to simultaneously carry out measurements in the short range and in the long range (frequency multiplexing mode) instead of alternate measurement (time multiplexing mode).

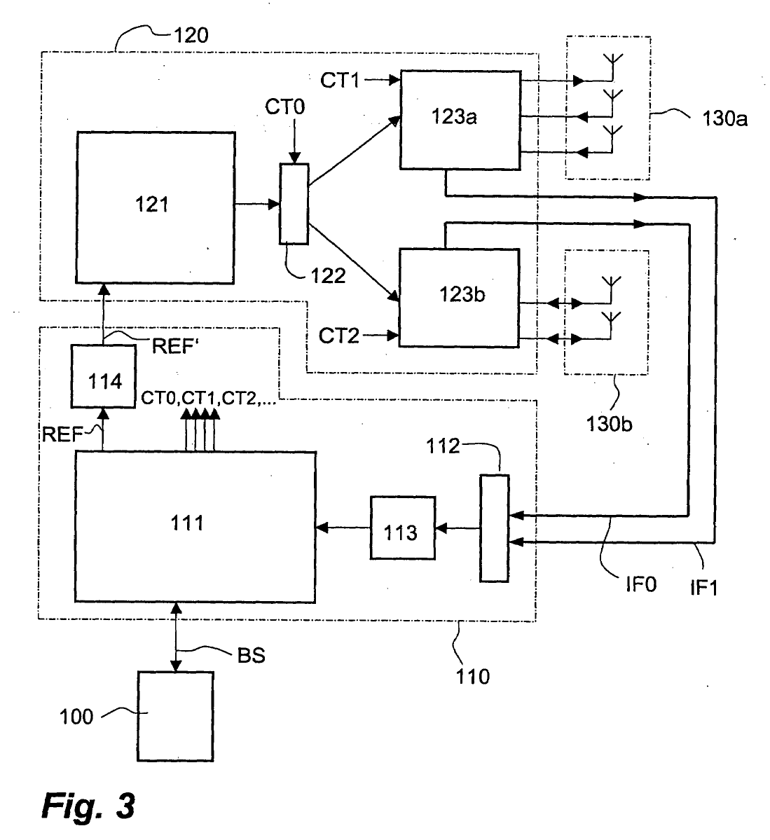

FIG. 3 illustrates essentially the same exemplary embodiment FIG. 2, but with the control and processing unit 110 and the radio-frequency transmission module 120 being illustrated in more detail. The control and processing unit 110 includes a computation unit 111, a digital/analog converter 114, an analog/digital converter 113 with an upstream distribution block 112 which, for example, may be in the form of a multiplexer. The radio-frequency transmission module 120 includes a radio-frequency oscillator 121, which produces the transmission signal, a distribution unit 122 which distributes the transmission path depending on the operating mode to a first transmitting/receiving circuit 123a or to a second transmitting/receiving circuit 123b (time multiplexing mode), or else between both transmitting/receiving circuits 123a and 123b (frequency multiplexing mode).

As already mentioned, the multirange radar has a first operating mode for measurement of distances in the short range, and a second operating mode for measurement of distances in the long range. The operating mode is determined by the computation unit 111 with the aid of the control signals CC0, CC1 and CC2 which it makes available. The control signals CT1 and CT2 respectively activate and deactivate the respective transmitting/receiving circuits 123A and 123B, and the control signal CT0 configures the distribution unit 122 in accordance with the intended operating mode. The computation unit 111 additionally provides a digital reference signal REF, which is supplied to the oscillator 121 via a digital/analog converter 114. This reference signal REF governs the instantaneous oscillation frequency of the output signal OSZ of the oscillator 121, which is supplied to the distribution unit 122. For a measurement in the short range, the distribution unit 122 is configured in such a manner that the transmission signal is supplied only to the transmitting/receiving circuit 123a, which is in turn activated by the control signal CT1. The second transmitting/receiving circuit 123b is deactivated by the control signal CT2. The transmitting/receiving circuits 123a and 123b essentially also include a transmission amplifier output stage via which the transmission signal is supplied to the respective antenna modules 1230a and 130b.

In addition, the transmitting/receiving circuit 123a contains one or more mixers with the aid of which the radar signals which are received by the receiving antennas are mixed to baseband. The baseband signal IF1 is then made available by the transmitting/receiving circuit 123a to the distributor block 112 in the control and processing unit 110. Depending on the number of receiving antennas, the baseband signal IF1 includes a plurality of signal elements. The baseband signal IF1 is distributed by the distributor block 112 to an analog/digital converter 113, which has one or more channels, and is made available from this analog/digital converter 113 in digital form to the computation unit 111. This computation unit 111 can then use the digitized baseband signals IF1 to identify objects in the “field of view” of the radar, and to calculate the distance between them and the radar. This data is then made available via an interface, for example a vehicle bus BS, to the rest of the vehicle.

For a measurement in the long range, all that is necessary is switching in the distributor unit 122, activation of the transmitting/receiving circuit 123b and deactivation of the transmitting/receiving circuit 123a by means of the control signals CT0, CT1 and CT2. The transmission and reception then take place via the antennas 130b, which in the present case are in the form of common transmitting and receiving antennas. For this reason, a directional coupler is also required to separate the transmission signal and the received signal. What has been said for the first transmitting/receiving circuit 123a also, of course, applies analogously to the second transmitting/receiving circuit 123b. The detailed design of the transmitting/receiving circuits 123a and 123b will be explained with reference to a further figure.

The transmitting/receiving circuits 123a and 123b can be deactivated in various ways. In the simplest case, the circuits (or else only circuit elements) are disconnected from the supply voltage. It is also possible to switch off the mixers in the transmitting/receiving circuits. Irrespective of the specific manner in which the deactivation is accomplished, it is, however, necessary to ensure that the power of the transmission signal is not reflected, and therefore does not interfere with any other circuit components.

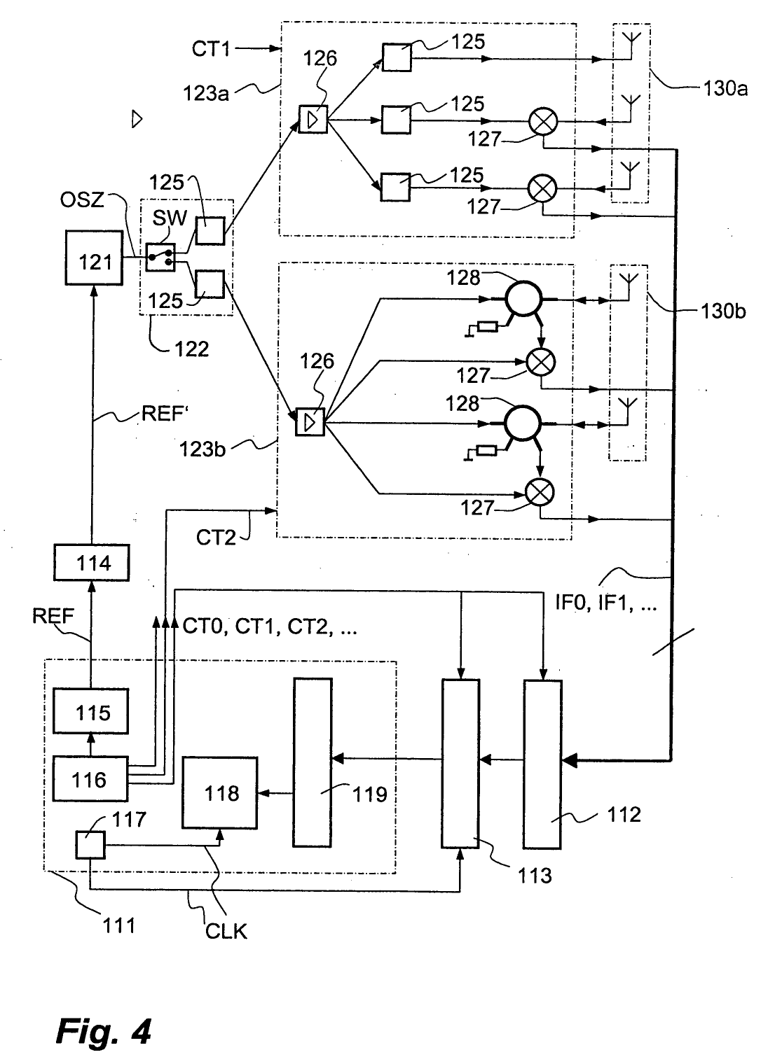

FIG. 4 essentially illustrates the same exemplary embodiments as that in FIG. 3, with the computation unit 111, the distributor block 122 and the transmitting/receiving circuits 123a and 123b being illustrated in more detail. The transmitting/receiving circuits 123a and 123b each have an amplifier 126 to which the transmission signal is supplied. These amplifiers 126 have a plurality of outputs, at least one of which is connected to a transmitting antenna, and at least a second of which is connected to a mixer 127. If interference signals which have to be filtered out are present, a filter 125 is in each case arranged between the amplifier 126 and the transmitting antenna, and between the amplifier 126 and the mixer 127. In the transmitting/receiving circuit 123a, the mixers 127 are connected not only to the amplifier 126 but also to the receiving antenna, so that the received signal is mixed to baseband with the aid of the transmission signal.

In the illustrated example, one transmitting antenna and two receiving antennas are provided in the antenna module 130a. This should be regarded only by way of example, and in principle any desired combination of transmitting and receiving antennas is possible. Instead of separate transmitting and receiving antennas, it would also be possible to use bidirectional antennas, as is the case with the antenna module 130b.

The transmitting/receiving circuit 123b differs from the transmitting/receiving circuit 123a described above by having the directional couplers 128 which allow the antennas in the antenna module 138 to be used both as transmitting antennas and as receiving antennas. The directional couplers 128 have four connections, of which a first connection is connected to the amplifier 126, a second connection is connected to a terminating impedance, a third connection is connected to a mixer 127 and a fourth connection is connected to one antenna of the antenna module 130b. The transmission signal is passed from the amplifier 126 through the directional coupler to the antenna, from where it is transmitted. A received signal is passed from the antenna through the directional coupler to the mixer 127, where it is mixed to baseband with the aid of the transmission signal, which is likewise supplied to the mixer 127. The output signals from the mixers, that is to say the baseband signals IF0, IF1 are then multiplexed by the distributor block 112, and are digitized by the analog/digital converter 113. These digitized signals are buffered by the analog/digital converter 113 in a FIFO memory 119 and are processed further by a digital signal processor 118. The FIFO memory 119 and the digital signal processor 118 are components of the computation unit 111, as is the clock generator 117, which provides a clock signal for the digital signal processor 112 and for the analog/digital converter 113. The control logic 116 provides the control signals CT0, CT1 and CT2 and likewise controls a reference signal generator 115, which produces the digital reference signal REF for the oscillator 121 (see above).

The distribution unit 122, which distributes the oscillator signal OSZ to the transmitting/receiving circuits 123a and 123a, has only one switch SW in the illustrated situation, which may, for example, be in the form of a semiconductor switch or a micromechanical switch. This switch connects the oscillator 121 either to the first transmitting/receiving circuit 123a or to the second transmitting/receiving circuit 123b. Filters 125 are likewise arranged between the switch SW and the transmitting/receiving circuits 123a, 123a, provided that interference signals are present. It is also possible to connect the oscillator directly to the two transmitting/receiving circuits 123a and 123b (that is to say without the provision of a switch SW), or to provide a passive power splitter. The oscillator power is then split between the two transmitting/receiving circuits. As already mentioned, it is important in this case to prevent reflections when one of the transmitting/receiving circuits 123a, 123b is deactivated. Suitable terminating impedances must therefore be provided at an appropriate point.

The exemplary embodiment illustrated in FIG. 4 is suitable for a so-called time multiplexing mode, that is to say switching takes place alternately from the first operating mode to the second operating mode, and back again. The frequency ranges for measurements in the near area in the first operating mode and for measurements in the far area in the second operating mode may in this case in principle overlap, since only one of the two antenna modules 130a or 130b is ever active.

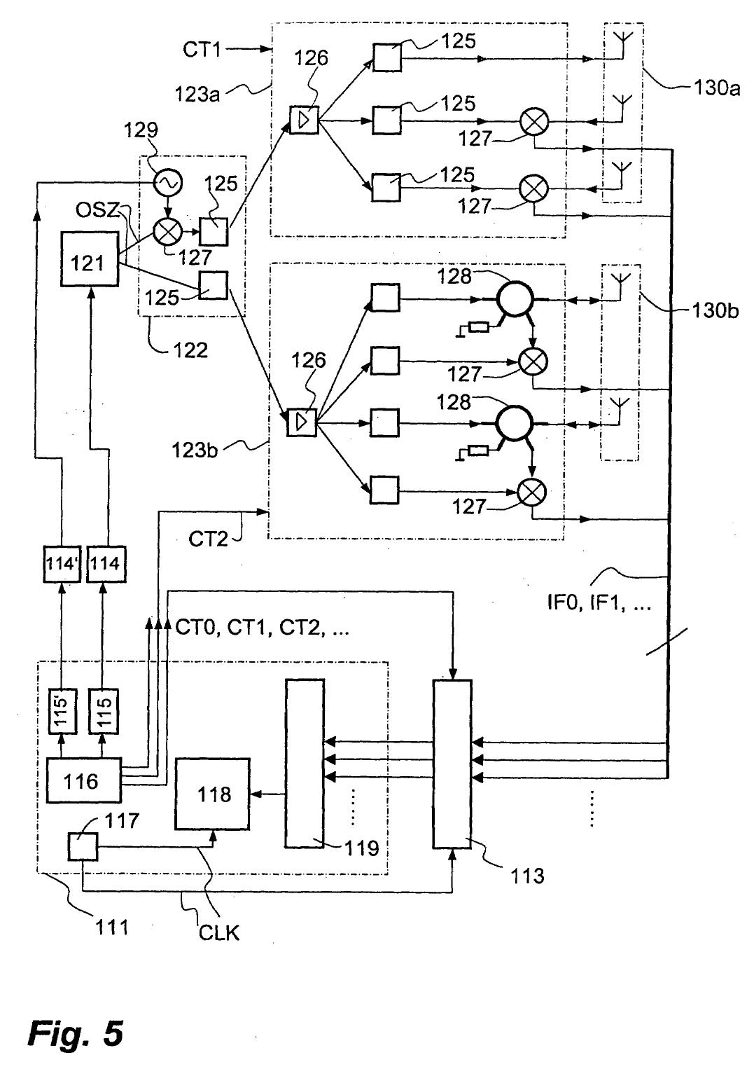

FIG. 5 illustrates a very similar exemplary embodiment which operates using the frequency multiplexing mode. This differs from the exemplary embodiment illustrated in FIG. 4 only by having a modified distributor unit 122, the additional reference signal generator 115′ with the additional digital/analog converter 114′. Since measurements are carried out simultaneously in the near area and in the far area in the frequency-division multiplexing mode, no multiplexer 112 is required in this case, but the analog/digital converters 113 must have a plurality of channels in order to allow the received signals, which have been mixed to baseband, to be digitized in parallel.

In the exemplary embodiment illustrated in FIG. 5, instead of a switch, the distributor unit 122 has an additional mixer 127 and an additional oscillator 129. The output signal OSZ from the oscillator 121 is on the one hand supplied to the mixer 127 in the distributor unit 122, and is on the other hand passed on via an optional filter 125 to the transmitting/receiving circuit 123b as well. The spectrum of the signal component of the oscillator signal OSZ supplied to the mixer 127 is frequency shifted through the oscillator frequency of the auxiliary oscillator 129, and is supplied via a filter 125 to the transmitting/receiving circuit 123a. The auxiliary oscillator 129 is likewise controlled by the computation unit 111 with the aid of the reference signal generator 115′ and the digital/analog converter 114′, which is connected to it and whose output signal is supplied to the auxiliary oscillator 129. The mixer 127 and the auxiliary oscillator 129 thus result in the production of a second, frequency-shifted transmission signal, so that the two transmitting/receiving circuits 123a can transmit and receive at the same at different frequencies via the two antenna modules 130a and 130b, respectively. This allows simultaneous measurement in the near area and in the far area.

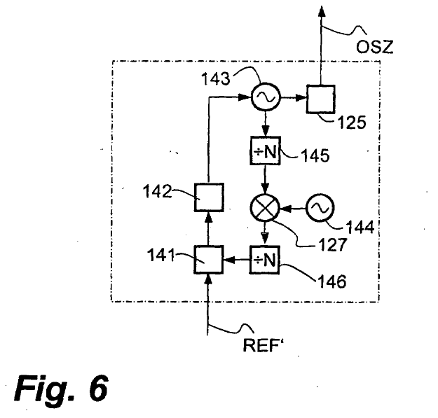

FIG. 6 illustrates one possible configuration of the radio-frequency oscillator 121, with whose aid the transmission signal is produced. This essentially includes a phase locked loop (PLL) to which the analog reference signal REF′ which is produced by the digital/analog converter 114 is supplied. The major element of the phase locked loop is a voltage-controlled radio-frequency oscillator 143 whose output signal is supplied on the one hand to a frequency divider 145, and on the other hand to a filter 125. The output signal from the filter 125 represents the output signal OSZ from the phase-locked loop. The output signal from the frequency divider 145 is supplied to a mixer 127 which uses an auxiliary oscillator 144 to shift the spectrum of the frequency-divided oscillator signal by the magnitude of the frequency of the auxiliary oscillator 144 towards a lower value. The output signal from the mixer is divided down once again by a further frequency divider 146.

The output signal from this further frequency divider 146 thus represents the oscillator signal of the radio-frequency oscillator 143, which is compared with the previously mentioned reference signal REF′ with the aid of the phase/frequency detector 141. This phase/frequency detector 141 produces a control voltage as a function of the frequency and phase difference between the output signal from the frequency divider 146 and the reference signal REF′. This control voltage is supplied to a loop filter 142, whose output is connected directly to the voltage-controlled radio-frequency oscillator 143. The voltage-controlled radio-frequency oscillator 143 is thus dependent on the phase difference and/or frequency difference between the output signal from the frequency divider 146, which represents the oscillator signal, and the reference signal REF′. The phase and the frequency of the output signal OSZ from the phase locked loop thus have a fixed relationship with the phase and the frequency of the reference signal REF′. The voltage-controlled radio-frequency oscillator 143 must be tunable over a broad frequency range, in the present case in the range from 76 GHz to 81 GHz, that is to say over a bandwidth of 5 GHz. Since the mid-frequency can also be shifted by temperature effects and other parasitic effects, a bandwidth of 8 GHz or more is required in practice, and this can be achieved only by using the modern bipolar or BiCMOS technology that has already been mentioned further above.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A radar system comprising:
a radio-frequency transmission module with an oscillator configured to provide a transmission signal with a first frequency spectrum in a first operating mode, and with a second frequency spectrum in a second operating mode;
at least one antenna connected to said radio-frequency module; and
means for providing control signals that are supplied to the radio-frequency transmission module for selecting between the first and second operating modes.

2. The radar system of claim 1, wherein the oscillator is tunable by means of a control voltage over a frequency range which includes the frequencies of both first frequency spectrum and the second frequency spectrum.

3. The radar system of claim 2, wherein a first range measurement is made in the first operating mode in a first range zone, and a second range measurement is made in the second operating mode in a second range zone.

4. The radar system of claim 1, wherein a transmission/reception characteristic of the at least one antenna can be switched by the control signals.

5. The radar system of claim 1, further comprising a first antenna for the first operating mode, and a second antenna for the second operating mode.

6. The radar system of claim 5, wherein the first antenna is active in accordance with the operating mode.

7. The radar system of claim 1, comprising at least one first antenna for measurement in said first range zone and at least one second antenna for measuring in said second range zone.

8. The radar system of claim 7, wherein both antennas are active at the same time for measurement in both range zones, said first antenna transmitting a transmission signal with said first frequency spectrum, and said second antenna transmitting a transmission signal with said second frequency spectrum.

9. A radar system for range measurement having a first operating mode for measurement in a first range zone and having a second operating mode for measurement in a second range zone, said radar system comprising:
a radio-frequency transmission module with an oscillator for providing a transmission signal with a first frequency spectrum in said first operating mode, and with a second frequency spectrum in said second operating mode;
at least one antenna connected to said radio-frequency module; and
a control and processing unit for providing control signals which are supplied to said radio-frequency transmission module for selecting said operating modes;
wherein said oscillator is tunable by means of a control voltage over a frequency range which includes the frequencies of both of said frequency spectra.

10. The radar system of claim 9, wherein a transmission/reception characteristic of said antenna can be switched by means of at least one of said control signals as a function of said operating mode.

11. The radar system of claim 9, further comprising at least one first antenna for said first operating mode, and at least one second antenna for said second operating mode.

12. The radar system of claim 11, wherein said first antenna or said second antenna is active, as a function of the operating mode.

13. The radar system of claim 9, further comprising at least one first antenna for measurement in said first range zone and at least one second antenna for measuring in said second range zone.

14. The radar system of claim 13, wherein both antennas are active at the same time for measurement in both range zones, said first antenna transmitting a transmission signal with said first frequency spectrum, and said second antenna transmitting a transmission signal with said second frequency spectrum.

15. A method of making a range measurement with a radar system, the method comprising:
taking a first measurement in a first operating mode for a first range zone;
taking a second measurement in a second operating mode for in a second range zone;
providing a transmission signal with a first frequency spectrum in the first operating mode, and with a second frequency spectrum in the second operating mode; and
providing control signals for selecting the first and second operating modes.

16. The method of claim 15 further comprising providing an oscillator for producing the transmission signal.

17. The method of claim 16, wherein the oscillator is tunable with a control voltage.

18. The method of claim 16 further comprising providing an antenna coupled to the oscillator.

19. The method of claim 18, wherein a transmission/reception characteristic of the antenna can be switched by means of at least one of said control signals as a function of the operating mode.

20. The method of claim 15 further comprising providing at least one first antenna for the first operating mode, and at least one second antenna for the second operating mode.
